(19) United States
(12) Patent Application Publication
(10) Pub. No.: US 2017/0103402 A1
(43) Pub. Date: Apr. 13, 2017

(54) SYSTEMS AND METHODS FOR ONLINE ANALYSIS OF STAKEHOLDERS

(71) Applicant: THE GOVERNING COUNCIL OF THE UNIVERSITY OF TORONTO, Toronto (CA)

(72) Inventors: Tamer EL-DIRABY, Mississauga (CA); Mazdak NIK-BAKHT, Toronto (CA); Sherif KINAWY, Toronto (CA)

(21) Appl. No.: 15/291,311

(22) Filed: Oct. 12, 2016

Related U.S. Application Data
(60) Provisional application No. 62/240,814, filed on Oct. 13, 2015.

(51) Int. Cl. G06Q 30/02; G06N 99/00; G06Q 50/00

(52) U.S. Cl. CPC G06Q 30/0201; G06Q 50/01; G06N 99/005

(57) ABSTRACT

Described herein are systems and methods for stakeholder analysis, and particularly for infrastructure project stakeholder analysis. An analysis engine models stakeholder data, such as social media comments, in the form of subject-sentiment dyads. A combination of the influence level of the person that generated the sentiment, the subject, and sentiment of the sentiment data provide a numerical model of the social media data as a data-point in the semantic space of the analysis. An aggregation of all data-points within a specific time interval then results in the profile of project-related discussions over that time period. Additionally, a knowledge engine provides a project-proprietary framework for receiving and classifying project-related stakeholder data.

### TECHNICAL FIELD

The following relates generally to systems and methods for stakeholder analysis and is more specifically directed to stakeholder sentiment analysis relating to infrastructure projects.

### BACKGROUND

Analysis of stakeholders can be crucial in a variety of contexts, including marketing, political analysis and infrastructure project proposals.

With respect to stakeholder engagement/analysis in infrastructure project proposals, two-way communication with prospective public users of an infrastructure system is a fundamental goal of public engagement in infrastructure planning. Although the role of online social media and collaborative software platforms is highly emphasized in this regard, the lack of tools, methods, and a formal process to distill the required business intelligence from public inputs has resulted in frustration for both the public and decision makers. This is especially true in the case of input obtained through social media.

Project teams—whether municipalities, public offices, or private entities—often face difficulties in communicating with stakeholders, such as the public, efficiently and effectively. Stakeholder analysis of technical fields like infrastructure planning and construction can present a challenge as the public and project teams use different terminologies to discuss impacts and perceptions.

A top-down approach in stakeholder management generally refers to the retrieval or analysis of public opinion based upon classification dictated by project teams. For example, in a top-down approach, a project team may dictate a format and classification scheme for collecting the perspective of the public with respect to the infrastructure project. A bottom-up approach on the other hand may conversely refer to a context where data is provided through public participation, which can thereafter be analyzed or classified by a project team to understand the stakeholders, their vested interests, how they are impacted, and their position regarding the infrastructure project.

### SUMMARY

In one aspect, a system for utilizing one or more internet-based sources including internet social networks to perform automated stakeholder sentiment analysis relating to infrastructure projects is provided, the system comprising: a user interface module configured to permit a user to obtain the stakeholder sentiment analysis; a knowledge engine comprising a recommender module and a wayfinder module for receiving structured and contextualized stakeholder analysis data through the user interface; an analysis engine comprising a subject classifier, a sentiment classifier, and a processing module, configured to: train the subject classifier and the sentiment classifier using the structured and contextualized stakeholder analysis data; retrieve a plurality of units of unstructured stakeholder analysis data from the one or more social networks; generate a subject-sentiment dyad for each unit by applying the trained classifiers to the unstructured stakeholder data; generate importance data by evaluating the importance of stakeholders associated with the unstructured stakeholder data, the evaluating comprising determining a social influence of the stakeholder utilizing a social graph of nodes and edges for the stakeholder from the one or more social networks; transforming the importance data to a set of directed vectors having magnitudes and directions corresponding to the dyads and importance data; generate a project profile from the directed vectors; and providing the project profile to the user via the user interface.

In another aspect, a method for automated stakeholder sentiment analysis relating to infrastructure projects utilizing one or more internet-based sources including internet social networks is provided, the method comprising: receiving structured and contextualized stakeholder analysis data through a user interface; training, by a machine learning approach, a subject classifier and a sentiment classifier using the structured and contextualized stakeholder analysis data; retrieving a plurality of units of unstructured stakeholder analysis data from the one or more social networks; generating, by an analysis engine comprising one or more processor, a subject-sentiment dyad for each unit by applying the trained classifiers to the unstructured stakeholder data; generating importance data by evaluating the importance of stakeholders associated with the unstructured stakeholder data, the evaluating comprising determining a social influence of the stakeholder utilizing a social graph of nodes and edges for the stakeholder from the one or more social networks; transforming the importance data to a set of directed vectors having magnitudes and directions corresponding to the dyads and importance data; generating a project profile from the directed vectors; and providing the project profile to a user via the user interface.

These and other aspects are contemplated and described herein. It will be appreciated that the foregoing summary sets out representative aspects of systems and methods for stakeholder analysis to assist skilled readers in understanding the following detailed description.

### DESCRIPTION OF THE DRAWINGS

A greater understanding of the embodiments will be had with reference to the Figures, in which:

FIG. 1 shows of a system for stakeholder analysis;

FIG. 2 shows a knowledge engine and an analysis engine of a system for stakeholder analysis;

FIG. 3 shows a method for stakeholder data analysis;

FIG. 4 shows a representation of a network of followers from a particular infrastructure discussion network for a particular infrastructure project;

FIG. 5 shows an illustrative architecture of a framework for an analysis engine to handle the processing of data collected from online social media;

FIG. 6 shows a modeling of the social media data illustrated in FIG. 4;

FIG. 7 shows a modeling of influence analysis for the social media followers illustrated in FIG. 4;

FIG. 8 shows a graph of possible stakeholder analysis data over time for a particular infrastructure discussion network;

FIG. 9 shows a graph of a project discussion profile over time the infrastructure discussion network of FIG. 8;

FIG. 10 shows possible project discussion profile for various communities of an infrastructure discussion network;

FIG. 11 shows an ontological model for a knowledge engine of the system comprising a project discussion framework;

FIG. 12 shows profile modalities for the project discussion framework;

FIG. 13 shows a communication framework for the project discussion framework;

FIG. 14 shows a representation of project and communication metrics;

FIG. 15 shows a representation of project and communication attributes;

FIG. 16 shows an embodiment of the project discussion framework's architecture;

FIG. 17 shows process flows for the project discussion framework;

FIGS. 18, 19 and 20 show data related to three implementations of a system for stakeholder analysis.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic discs, optical discs, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile discs (DVD) or other optical storage, magnetic cassettes, magnetic tape, magnetic disc storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

As some efforts have indicated, the prevalence of social media, its openness and bottom-up nature of expressing opinion makes it difficult for any project-proprietary website or service to compete against it in terms of engaging the public, distilling knowledge from them, and educating them about the project. Most current public involvement practices that make use of social media use Twitter™ as a one-way communication channel to post news and updates regarding a project.

Applicant has determined that distilling project-related knowledge from social media, however, requires social network analytics to understand the project followers as well as semantic analysis of the contents they communicate about the project.

Embodiments of a system described herein comprise a knowledge engine and an analysis engine at a back-end to support a user-Interface (“UI”) at a front end. The engines automate the analysis of stakeholders' inputs, applicable to particular fields, including infrastructure projects. At the front-end, the UI provides an online communication channel that inherits attributes of the social web and provides incentives to both project and public teams to interact with it. At the back-end, the two engines use the rich source of information on a project either shared by the project team, or generated from online social media, and automates understanding, classification, and interpretation of the data. Further, embodiments connect the data to the identity of people contributing to generating them. Current limited attempts for understanding end-users and completing the associated communication loop are based on manual screening and classification of users' inputs (such as tweets, blogs, Facebook™ posts, etc.).

Described herein are the engines of the system and the process through which the two analyze and then synthesize the unstructured data points into structured/relevant project information. The system particularly focuses on stakeholder analysis for infrastructure projects. The knowledge engine provides a project-proprietary framework behind a user-interface (“UI”) platform for receiving and classifying project-related stakeholder data. The analysis engine provides analysis of social media feeds and the social network formed behind it within the framework built by the knowledge engine.

More particularly, described methods distill stakeholders' knowledge in a bottom-up manner by collecting stakeholder data from various resources (such as social media comments), and modeling them as subject-sentiment dyads in the semantic space of a project-related context. A knowledge engine uses a combination of an ontology, a wayfinding module and a recommender module to extract meaningful and directed feedback from the public, and based on that define the main dimensions of the semantic space, as the main topics discussed in a project by its stakeholders. The knowledge engine may define dimensions of the semantic space and provide training data to train classifiers of an analysis engine. To detect the subject and sentiment, classifiers of an analysis engine may thus be trained to understand the specific context of infrastructure projects. Further, to evaluate the importance of the person who has left the sentiment data, influence analysis may be carried out by the analysis engine of nodes in the social network of project followers. A combination of the influence level, the subject, and sentiment of data provides a numerical model of social media data as a data-point in the semantic space of analysis for a project. An aggregation of all data-points within a specific time interval then results in the profile of project-related discussions over that time period.

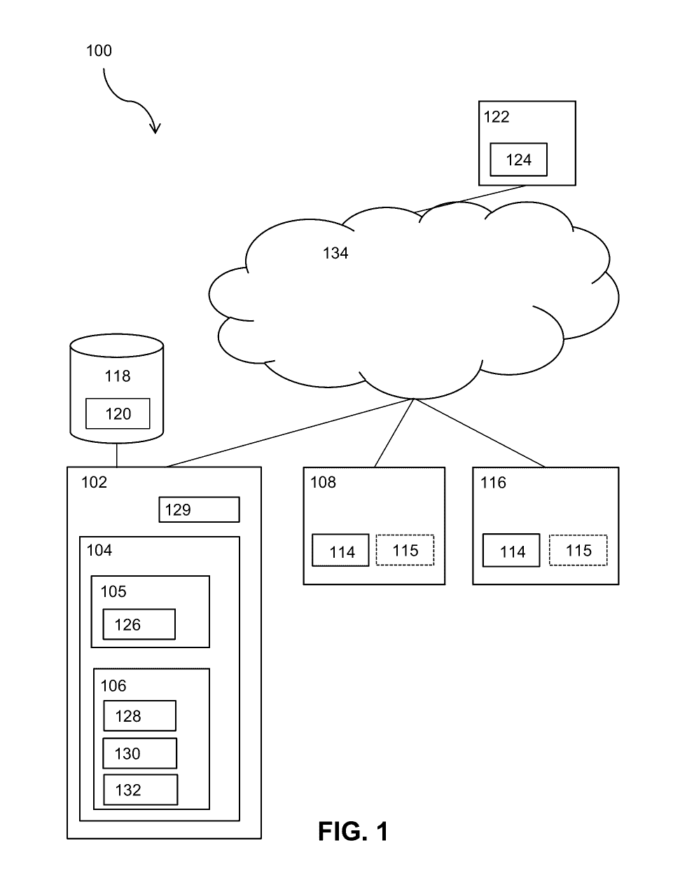

Referring now to FIG. 1, shown therein is an embodiment of a system for stakeholder analysis. The system 100 comprises a server 102 and a team member device 108. The system may further comprise a stakeholder device 116 and/or a social media platform 122.

The server 102 comprises or is communicatively linked to a database 118 for storing stakeholder analysis data 120. The database 118 may further comprise user information for users of the system, such as user credentials. The server may be a hardware server, or may be a virtualized server. The stakeholder analysis data 120 generally comprises data relating to stakeholder opinion, such as public opinion on infrastructure projects, which may include social media data (e.g. ‘tweets’) and internet forum comments posted by stakeholders relating to infrastructure projects. Stakeholder analysis data 120 may be received from infrastructure discussion networks (“IDNs”) of a social media platform 122. Embodiments provided herein describe analysis of tweets for clarity of illustration; other stakeholder analysis data can be used. Further, though stakeholder data in the context of infrastructure-related projects is described, this is not intended to be limiting to such applications.

The server comprises a back-end module 104 and an associated frond-end module. The front-end module comprises a user interface 129 accessible over a network 134 for the server (“web interface”). Network 134 may be a wired or wireless communication network. The back-end module 104 provides access to stakeholder analysis management and services hosted at the server, the functionality of which is described herein. Particularly the back-end module 104 comprises an analysis engine 105 and a knowledge engine 106. The server 102 may comprise a processor for processing stakeholder analysis data 120 in conjunction with computer/executable instructions for providing the functionality described herein.

Project team members and stakeholders, as described in the background section above, are referred to generally herein as “users” of system 100. Project team members may each access the system from a team member device 108. Stakeholders may each access the system from a stakeholder device 116. The users may have to input user credentials to the web interface before being able to access functionality of the system.

Team member device 108 is a computing device for accessing the system by a project team member for managing or analyzing stakeholder analysis data for an infrastructure project. The team member device may comprise an input device 114. The input device comprises a user interface device, such as a touchscreen or a computer peripheral for facilitating data entry to the team member device 108.

The stakeholder device 116 is a computing device for accessing the system by a stakeholder. The stakeholder device may similarly comprise an input device 114.

Social media platform 122 may be accessed over network 134 for providing stakeholder analysis data of an IDN. Social media platform 122 may comprise an application program interface (“API”) 124 for providing access to stakeholder analysis data, such as “tweets” or comments.

The back-end module 104 comprises at least analysis engine 105 and knowledge engine 106. Although each of these two may be functional independently from the other one, a hybrid system comprising both engines 105 and 106 provides full functionality of the system (to complete the automation).

It will be appreciated that a client-side application 115 at the team member device 108 and the stakeholder device 116 may be provided to interact with the server 102 over the web to provide the same functionality as a server-based application as described herein, with some modifications that will be appreciated to those of skill in the art. A client-side application might provide for additional functionality to improve the user experience, including the provision of context menus in an operating system and providing other functionality, as well as integrating with resources stored at the team member and stakeholder devices.

The analysis engine 105, the knowledge engine 106 and their associated functionality will now be briefly described with regards to FIGS. 1 to 3. These modules will be described in more detail for specific implementations below.

Analysis engine 105 models each data-point from stakeholder analysis data—such as a tweet or a comment—as a subject-sentiment dyad in the semantic space of project-related discussion, each data point representing a particular opinion. In an automated system, the analysis engine may rely on classifiers 126 to classify each data-point and detect its subject and sentiment. Further, the importance of a stakeholder that left the comment is determined through analysis of their social network. A combination of the influence level, the subject, and sentiment of the tweet provides a numerical model of that tweet/comment as a data-point in the semantic space of that project analysis. Once a sufficient number of data points are modeled, a project sentiment profile for a project can be generated by the engine 105, referred to herein as a project discussion profile (“PDP”) 158. The analysis engine 105 may model and analyze data stored at the server or may sample data from social media platform 122. However, as a starting point, the analysis engine may require the main subject classes upon which to classify the data-points. These subject classes may be provided by the knowledge engine 106. Further training sets of data may be received from the knowledge engine to facilitate automation of classification.

The knowledge engine 106 provides a framework accessible in the web interface comprising an ontology 128, a wayfinding module 130 and a recommender module 132 to extract meaningful and directed feedback from stakeholders. The ontology is used as a basic knowledge layer. For infrastructure-related projects, the ontology may comprise infrastructure concepts. The wayfinding/recommender modules direct stakeholder users to infrastructure projects that they may be interested in, in order to direct feedback. Once received, this feedback can be modeled in the form of comments and tags and can be used as the main subject classes by the analysis engine. This framework for the communication process between the public and other stakeholders and project managers facilitates continuous rapid analysis of stakeholder data. The knowledge engine module thus provides a project-proprietary platform for infrastructure sentiment communication and discussion, and collects the main topics of interest for a specific project, along with sets of comments within each topic, to be used in training the classifiers for the analysis engine.

As part of the knowledge engine, the recommender module and wayfinding module depend on an ontology 128 to add context based on the location of a project (city, neighborhood, etc.) and the type of infrastructure project (transit vs. water treatment plans). This allows the framework to create meaningful conversations about impacts, functions, and perceptions, as opposed to technical project aspects. The development of the ontology may use domain documents such as public meeting records, project documents, and regulatory guidebooks to build this context which then supports the framework as a whole in directing users to relevant content and categorizing user-generated content for easier concept-matching and analysis by project managers. Recommender systems for some large platforms, such as Amazon™, enhance user experience by directing users to content that match their profiles. However, unlike books, complex projects such as a transit projects are harder to recommend based on basic user-profiles. Embodiments of the recommender module 130 enhance the user profiles automatically through user activity and knowledge inference.

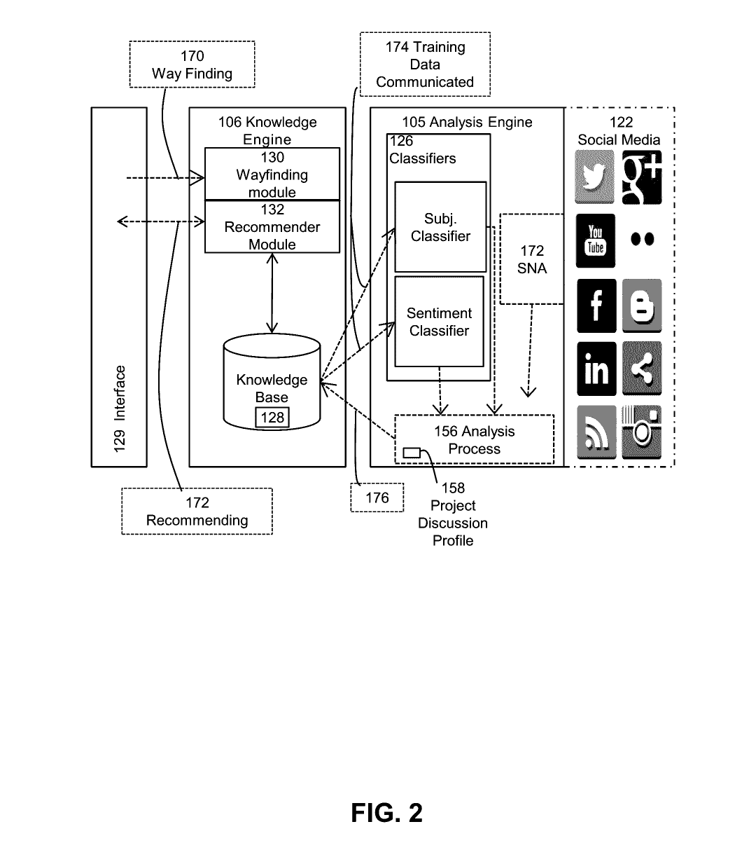

Referring now to FIG. 2, shown therein is a view of the knowledge engine 106, analysis engine 105 and interface 129, illustrating an example flow of data between the components. As illustrated, the knowledge engine comprise comprises a wayfinding module 130, a recommender module 132, and a customized knowledge base which generally comprises a customized ontology 128. The analysis engine comprises classifiers 126. As illustrated at block 170, 172, the wayfinding module 130 and recommender module 132 are configured to direct users to relevant projects through a user interface 129. Contextualized and structured stakeholder analysis data are therefrom received for each project, the structure and context being provided by the knowledge base for each project. The contextualized and structured stakeholder analysis data may be provided as training data at block 174 to the analysis engine. The analysis engine can utilize the training data for training subject classifiers and sentiment classifiers. Data can be retrieved from social networks, and social network analysis 172 can be performed thereupon utilizing the trained classifiers. A project discussion profile 158 can be generated and provided back to the knowledge base at block 176.

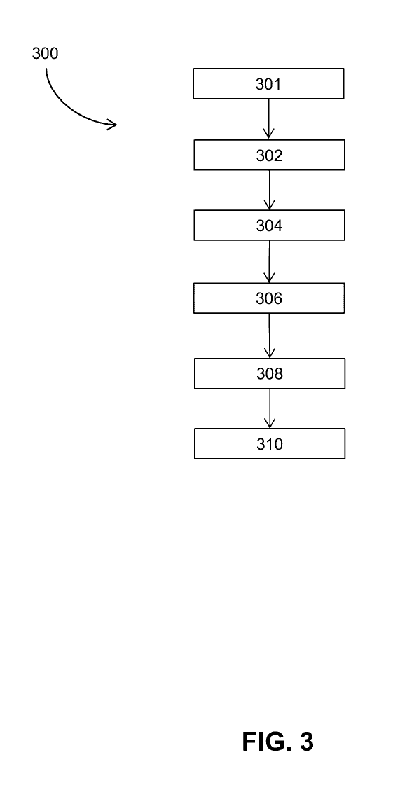

Referring now to method 300 of FIG. 3, shown therein is a method of processing stakeholder analysis data utilizing the system 100. At block 301, an IDN may be processed to determine a network of project followers for a particular project, as described below. At block 302, to determine subject and sentiment for a given piece of stakeholder analysis data, the data is provided to classifiers that have been trained to understand the specific context of infrastructure projects. For classification—such as for classification by sentiment—context is required because positive and negative sentiments have different connotations in the opposing contexts of approving or disapproving a project. Merely detecting happy/sad sentences may not provide for accurate classification, as for many other applications outside of infrastructure projects. At block 304, once a data-point is modeled, the importance of the person that left the tweet is determined through influence analysis of nodes in the social network of the project followers. At block 306, influence level, the subject, and sentiment of the data point will be combined to provide a numerical model of the stakeholder analysis data as a data-point in the semantic space of the analysis. At block 308, an aggregation of all data-points within a specific time interval then results in the profile of project-related discussions over that time period, referred to as a “Project Discussion Profile” (“PDP”). At block 310, the profile may be output to a project team member for review of infrastructure project sentiment by stakeholders. The insights obtained by applying this method can be used for detecting trends in opinion for a project and therefore can provide useful inputs for decision making and public involvement.

Referring specifically to blocks 301 and 304, to detect typology of stakeholders, the method combines community detection, influence analysis, and text mining tools to detect and classify clusters of project followers based on their social connectivity, and interpret common interests among different clusters. For this purpose, a social network of project followers can be formed and communities of such networks can be detected. From this, an aggregation of user profile descriptions in each community can be analyzed through a measure which is a product of term-frequency, inverse-document frequency (“tf-idf”) of terms in each user's profile description, and the influence level of that user. This measure—referred to henceforth as “modified tf-idf”—increases the relevance and accuracy of results by linking user descriptions into their importance level, achieved based on the social linkages they are involved in. Combining social network analytics and semantic analytics in the process not only detects the cores of interest in a project, but also highlights the important stakeholders behind those ideas.

The back-end module 104 thus relies on the outputs of the analysis engine 105 providing social network analyses and text mining to detect, model, and analyze infrastructure-related inputs from social media in a quantitative way. Some methods in the domain of infrastructure analysis (such as the SNAPPatx project) mainly focus on analysis of subject and sentiment of tweets. However, the analysis engine 105 links the opinion (subject/sentiment) to the identity of people supporting them and evaluates the public opinion about an infrastructure project in a more realistic way. In addition to feeding the analysis engine, the knowledge engine module 106 promotes knowledge discovery through assisted information navigation and collaborative learning. The knowledge engine module 106 also provides a decision-support communication system customized to technical fields such as infrastructure planning.

The aggregation of the knowledge engine and analysis engine can provide decision makers with a more profound and meaningful perspective of the public opinion about a project and its dynamics in response to decisions that are made. The system may thus provide a more realistic and extensive analysis of public opinion which may be provided at reduced cost as compared to current alternative methods, which are often off-line.

Further, given the nature of urban infrastructure systems and the wide range of its internal and external stakeholders, providing a clear segmentation of the main stakeholders and their vested interests is a challenge in most of the projects. The system 100 can greatly support the process of analyzing stakeholders typology by highlighting the social clusters (communities) of followers, profiling them along with their interests, and highlighting their learning curve with respect to the project. Many of these goals may not currently be attainable through some off-line engagement methods, given the limited time and outreach of such methods as well as the diversity of learning methods in different groups of project followers.

Further, the back-end module 104 may be customized for the specific context of civil infrastructure. The backbone ontology, the subject and sentiment classifiers trained to detect issues related to urban projects, and the position of project followers with respect to them, as well as the process of synthesizing analytics to develop a project discussion profile may all be tailored for a specific context—such as infrastructure projects.

Still further, the system enables a true two-way communication channel between the project team and the public, with a self-organizing nature. This not only provides public involvement practitioners with access to the real-time mental map of prospective users of the system, but also enables them to provide the project followers with the right content at the right time, at the minimum maintenance cost.

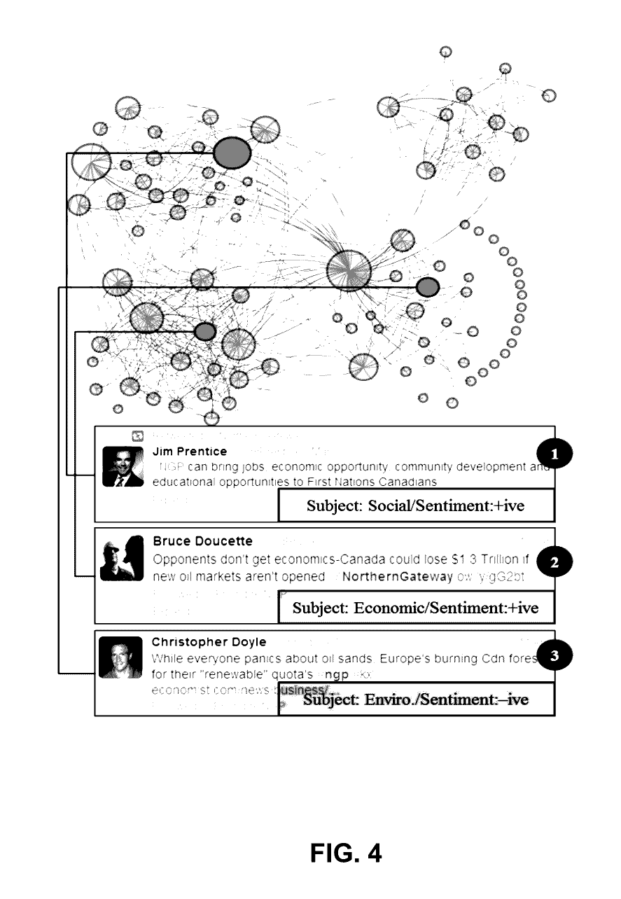

The back-end module 104, the analysis engine 105, and the interaction between the analysis engine 105 and the knowledge engine 106, will now be described in additional detail with regards to FIGS. 4 to 10.

The analysis engine 105 thus processes stakeholder analysis data from IDNs and models data as dyads of subject-sentiment, and evaluates each dyad based on the network value of the stakeholders who are involved in it. Subject refers to the aspect of the project addressed by the discussion. It can reflect the specific ‘interest’ of the individual who has started, or participated in a discussion. As an example, if the knowledge engine detects “sustainability” to be the main topic of interest in a project, then within the scope of sustainability, each of the Environmental, Economic, Engineering, and Social components can be representative of a line of interest (one dimension of the semantic space) in that infrastructure project. Sentiment represents the position of the individual starting or supporting a discussion. Further, the importance level of a stakeholder may be determined and is reflective of the position the individual has in a network of project followers as a result of interactions among all nodes in a self-organized manner. This can be simply associated with the level of influence an individual has on other followers of a project. Discussions started or supported by nodes that have a higher level of influence, have a higher chance of being noticed, contemplated, or even accepted by others.

In order to encapsulate the knowledge from the analysis of stakeholders' project followers' behaviours over online social media, their opinions (as dyads of the subject and sentiment) must be linked to their identities (in terms of their level of influence and the community they belong to). Aggregating such linked opinions over time can provide decision makers with a perspective of the social opinion with respect to a project and social response to decisions they make.

In the following, analysis of an IDN as a social network of project followers (a subset of stakeholders) and the opinions expressed inside the network will be described. The result of the analysis may be provided in the form of a decision support tool such as a PDP, which may highlight dynamics in the opinion of project followers, based on topics they discuss, their position with respect to the project, and their level of influence on other followers. The higher the level and probability of impact for a stakeholder are, the more critical their satisfaction will be in the process of decision making.

As described above with reference to blocks 301 and 304 of method 300, when evaluating stakeholders analysis data from an IDN, the IDN can be modeled as a social graph of the project's followers. The social graph of followers of a project can be formed as a collection of nodes, representing project followers, along with edges, modeling social linkages among them. Following by one project follower on Twitter™ of another, friendship on Facebook™ subscription on YouTube™, etc. are examples of such social linkages on different social media platform. All these linkages may be detected by communication through an API of a target platform. Referring now to FIG. 4, shown therein is a representation of a network of followers from a particular IDN for a particular infrastructure project, showing particularly a simplified representation of an IDN as a network of people and ideas. Specifically, FIG. 4 shows a selection of Twitter followers for the Northern Gateway pipeline project (Alberta and British Columbia—CA). This particular network shows a very clear example of conflicts between the three components of Social, Environmental, and Economic sustainability at a high level. Despite the high amount of local, provincial, and federal tax revenue, as well as temporary and permanent job opportunities that the project will create for the local communities, it has been involved in extensive disputes for a long time. The pipeline passes through aboriginal lands and environmentally protected regions; risk of contamination due spillage and also increase in the green-house gasses due to burning the exported petroleum are among other main themes of dispute. Analyzing stakeholder analysis data from an IDN, as described above, requires evaluation of network value (i.e. influence level) for the stakeholders, and classification of subject and sentiment for the ideas discussed. Several methods and metrics are possible for evaluation of influence degree of nodes on others in the social networks. One such method, PageRank can take into account both quantity and quality of followers for each individual. PageRank returns a weight between 0 and 1 for each node, which can be normalized and taken as the rank of influence for nodes of a network. In FIG. 4, the size of nodes reflects their level of influence according to their PageRank weight. FIG. 4 shows only a small portion of a huge network with more than 1700 nodes.

Referring now to block 302 of method 300, the second aspect of the IDN analysis is related to the ideas discussed. As mentioned, in order to model the ideas expressed by comments, they must be classified in two dimensions: subject (topic), and sentiment. These two together can be used to classify the opinion expressed by a data-point. The problem of classification for the subject and sentiment may be considered as a supervised learning problem. The classes for sentiment can be pre-determined as: supportive (proponent), opposing (opponent), or neutral. Machine Learning (“ML”) helps to train classifiers to solve such a problem. By selecting a specific context (scope) classification of the subject will also become a supervised classification. In the system, the knowledge engine provides the context as the set of topics discussed more frequently for a specific project. For example, selecting ‘sustainability’ as the context of analysis of the project described with reference to FIG. 4, specifies the subject classes as Economic, Environmental, Social, and Engineering sustainability.

Training a subject classifier is a case-dependent problem; a classifier may be trained using a set of annotated data-points (training data), where texts with pre-determined classifications are provided for training. This may be provided by the knowledge engine in the system. Different methods and tools such as Support Vector Machine, Logistic Regression, Naïve Bayesian classification, and Decision Trees are used for this purpose. Sentiment classifiers have been developed in the literature based upon different corpora, including tweets, but off-the-shelf classifiers may be of limited use for IDN analysis. It has been shown that classifiers trained in this way are topic-dependent, domain-dependent, and temporally-dependent (Read 2005). For example, in the specific context of the analysis of by the engine 105, positive sentiment applies to sentences approving the project or a certain aspect of it. This can happen in form of sentences with either positive (happy) or negative (sad) sentiments.

Once trained classifiers are obtained, data-points, such as tweets, can be collected from a social media platform 122. For example, tweets can be obtained from Twitter using relevant hashtags (#) or by mentioning the project's handle (@) and can be classified based on the subject the tweet discusses, and its sentiment (position) with respect to the project. In FIG. 4, three sample tweets are shown each discussing a different aspect of the Northern Gateway project. As shown, these tweets are detected through hashtags such as #NGP or the project ID handle @NorthernGateway. Processing this data using the classifiers discussed can tag them based on their subject and sentiment. Examples 1 to 3 in FIG. 4 respectively discuss the Social, Economic, and Environmental sustainability of this project, with positive, positive, and negative sentiments respectively.

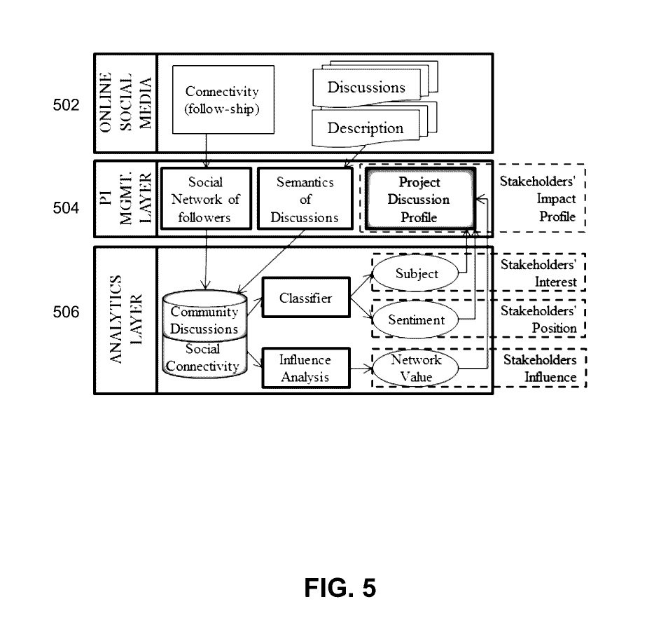

Referring now to FIG. 5, shown therein is an illustrative architecture of a framework for the analysis engine 105 in order to handle the processing of data collected from online social media into knowledge useful for decision making. The framework includes three main layers. Interface layer 502 will be a social media platform. Instead of requiring a project proprietary channel to engage the online community, the engine 105 may use an open API, such as API 124, of an online social media platform to collect data generated and openly shared by the public in a pro-active manner.

Two types of data may be collected: connectivity among the project followers (who follows/supports/mentions whom), and followers' context, including user descriptions (available in their profiles); and the content of topics they discuss through their posts. At the analytics layer 506, collected data may be stored in relational databases—such as within database 118. Data on social connectivity is processed to detect patterns of influence and to evaluate network value of each IDN member. The content of posts is processed and will be classified in terms of their subject and sentiment.

The role of project team members (such as decision makers) may be to act as a process architect/manager rather than a project controller. Therefore, the management layer 504 of the proposed model may help to manage online participation of followers and detect patterns of such participation. Detecting and collecting relevant data in the two groups, communicating with the analytics layer, and disseminating results of analysis may take place in this layer. Network value of users and subject/sentiment of discussions may be combined in this layer to transform every single data-point into a meaningful piece of information. Aggregation of such information and visualizing the results over a specific period of time may profile the opinion of project followers with respect to the project and decisions made in it in a PDP. The PDP may act as a collective index of the followers' opinion. This will be a useful decision support tool for project team members.

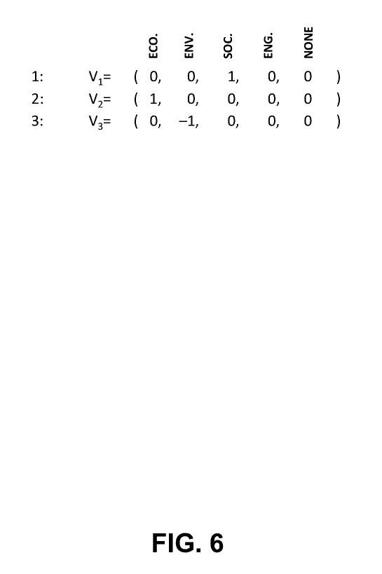

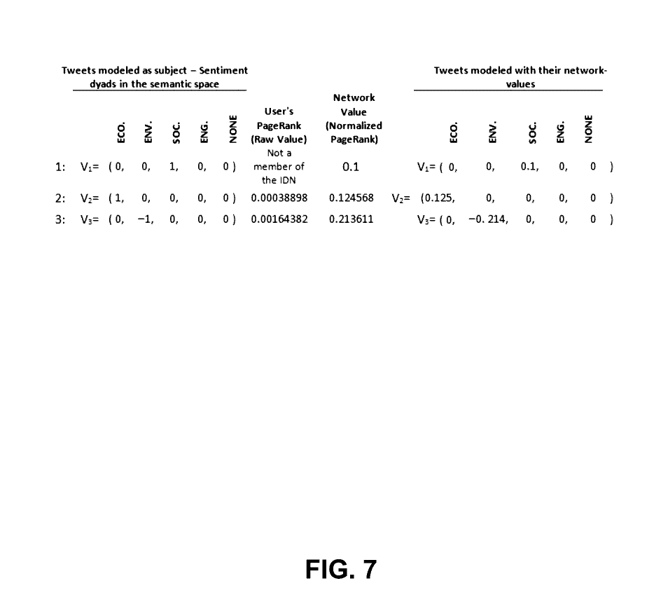

Mechanics of the framework and particularly the way the data is modeled, combined, and synthesized into a project discussion profile will now be described with reference to FIGS. 6 to 7.

Each relevant data-point detected and collected in the online social media must be evaluated, classified, and quantified from the three aspects of subject, sentiment, and network value, as discussed above. In the following, the procedure will be explained for tweets collected by following certain anchors (e.g. a hashtag: # or a handle:@). The same methods, can be performed, with necessary modifications, to receive data from other online platforms that allow tracking the connectivity among users and archiving their comments.

Determination of a specific context for modeling data will be described with reference to FIG. 6. Context can be modeled as a set of topics and subjects which together form the scope of the analysis. An ontology may provide a backbone for modeling the context of topics and subjects. The knowledge engine provides such an ontology, and classification of project documents as well as followers' inputs in that engine highlight the parts of the ontology which are of higher interest of the stakeholders. These are sent back to the analysis engine as the main topics (subjects) forming the analysis context. A semantic space may be defined, dimensions of which represent the topics which collectively define the context of the analysis. For example, selecting sustainability as the context, its main components (Economic, Environmental, Social, and Engineering) may form the dimensions of the semantic space. Dimensions of the semantic space can be increased by adding new topics to the scope (expanding the scope), or through adding subclasses of the semantic classes (going into more depth). However, the semantic space may need an additional dimension orthogonal to the topics forming the scope, to represent ‘out of scope’ discussions; this is called a “None” here.

Each data point, such as a tweet, expressing an opinion on a certain aspect of a project, as mentioned before, is modeled in the form of a subject-sentiment dyad. Taking the semantic space of the analysis as a vector space, such a data-point can be modeled as a vector. Entries of such a vector will be associated with the topics of the context and their values can represent the level of dependency between the tweet and each of those topics. This can simply happen in a binary format (e.g. a one representing that the specific topic has been covered and a zero stating that the topic has not been discussed by the tweet). Although more sophisticated setups can be thought of (such as assigning values proportional to the degree of relevance of the discussion to the certain topic); the binary values can competently serve the purpose of analysis.

In order to reflect the sentiment of a tweet with respect to the topics it discusses, the method may be followed from Olander, S. (2007), Stakeholder impact analysis in construction project management, Construction management and economics, 25, 277-287. The sign of entries may be used to refer to the sentiment; a positive sign for a vector entry means that the tweet is in favour of the project (or a specific decision) from the certain aspect represented by that dimension, and a negative is the sign of opposing it. As an example, following the convention explained above, the three tweets shown FIG. 4 can be modeled as shown in FIG. 6. Note that it is possible for a tweet to discuss more than one aspect of the project and in that case, the vector may have more than one none-zero entries.

However, a comment may refer to a specific aspect of a project without a certain sentiment. This happens in cases such as mentioning news, updates, or facts about the project. Therefore, modeling opinion may be involved in a third mode: the ‘neutral’ sentiment. Such situations are modeled by zero and therefore, each vector can take one of three possible values. One consequence of such an assumption is the fact that there is no distinction between a tweet not discussing a certain aspect of a project, and a tweet discussing it without a specific sentiment. This is acceptable since a project discussion profile is supposed to be a decision support tool to highlight the level of public satisfaction (or dissatisfaction) with respect to different aspects of a project. But in order not to miss any public inputs, results of enumerating tweets in different aspects of the project may be visualized and presented along with the project discussion profile. This can indicate which aspects of a project have been generally paid attention by different groups of followers over the time.

Influence analysis for project followers will now be described with reference to FIG. 7. As described above, the identity of utterers of stakeholder analysis data must be attached to the content they discuss, in the form of their influence level. Network value of a discussion may depend on the influence level of the individual starting it, or individuals who respond to it. The influence level of a node in the IDN, as discussed above, can be calculated through the PageRank measure which returns a number between 0 and 1. This is a relative value, showing the degree of influence for a node compared to other nodes of the network. This number is an indicator of the penetration level for ideas created or promoted by a node in the IDN. Therefore, if assuming that being seen by more number of nodes with higher influence levels grants a higher network value for a discussion, then this measure can be used as a weight to amplify the ideas discussed in connection with their supporters.

As the profile of project discussions may be derived over the time, the network value of IDN members must be calculated based on different snapshots of the network. As mentioned above, the absolute value of PageRank does not necessarily have a specific meaning; rather it only shows the rank of a node in a network in terms of its influence level. Therefore, while comparison among PageRank of different nodes within the same snapshot of a network can provide a precise judgment about their relative influence levels; comparing the value of PageRank for nodes (or even for the same node) in two different snapshots (which are mathematically two different graphs) may not be meaningful. The value of PageRank may be normalized in various snapshots to indicate the ranking before being used in time-dependent evaluations.

A project may receive ideas from nodes outside its mapped IDN. This happens, for example, when people who are not connected to the project's Twitter ID (and therefore are not in the social graph of its IDN), tweet about the project and anchor their tweets by mentioning the project ID or using relevant hashtags. Such tweets shouldn't be ignored in the project discussion profile; not only are they a part of inputs reflecting the social opinion about the project in the online environment, but also in many cases they can be seen, replied, or re-tweeted by members of the IDN. The PageRank however, will return a zero for any node outside a network, and therefore, tweets by such nodes will be filtered out if the raw value of the PageRank is used as the network value of discussions. In order to address this, the value of PageRank may be normalized for nodes in each network between 0.1 (instead of 0) and 1. The weight of the node with the highest PageRank value may be taken equal to 1, and the weight for pseudo orphans (which have the lowest level of PageRank), may be taken as 0.1. The weight for all other nodes may then be interpolated between 0.1 and 1 according to their PageRank values. The minimum weight (0.1) may thus be assigned to nodes outside the IDN to include relevant tweets by such nodes in the analysis, but with the lowest network value possible. Moreover, the project ID, as the ego of the IDN, will always have the highest PageRank value. Given the ego-centred structure of the IDN, this value is so high that tweets by this node will overshadow any other idea discussed over the IDN. The weight of the project ID may be taken as (1) but this node is set aside from the process of interpolation. The interpolation will be run in the range of the pseudo-orphans' PageRank as the weight of 0.1 and the second highest PageRank in the network (the node with the highest PageRank, after the project itself) as the weight of 1.

By multiplying a data-point's vector representation by the normalized influence weight of the person who has tweeted it, a weighted vector will result which represents the tweet along with its network values. For instance, in the example of the three tweets presented above, looking up the PageRank of nodes in the IDN of the Northern Gateway Pipeline project, and normalizing them based on the maximum and minimum PageRanks in the network results in the following weighted vectors shown in FIG. 7. After all inputs related to a project are collected, pre-processed, and modelled in the semantic space of the analysis in conjunction with their network value, they may be aggregated to give an overview of the collective opinion of the project followers. The result, referred to herein as Project Discussion Profile (“PDP”), can help decision makers to understand stakeholders (or at least the project's online followers), their point of view within a selected context, and the dynamics in their position with respect to the decisions made.

Apart from selecting a context, generating a PDP may require an analysis timeframe. Inputs can be accommodated and aggregated within specific time intervals, and then trends of change over the time can reflect the opinion dynamics of project followers. Generally, the dynamics of opinion evolution in a social network is a continuous and nonlinear problem in nature. Prediction of opinion dynamics over time may be complex; PDP may provide a good solution to a need to monitor patterns of opinion in different timeframes.

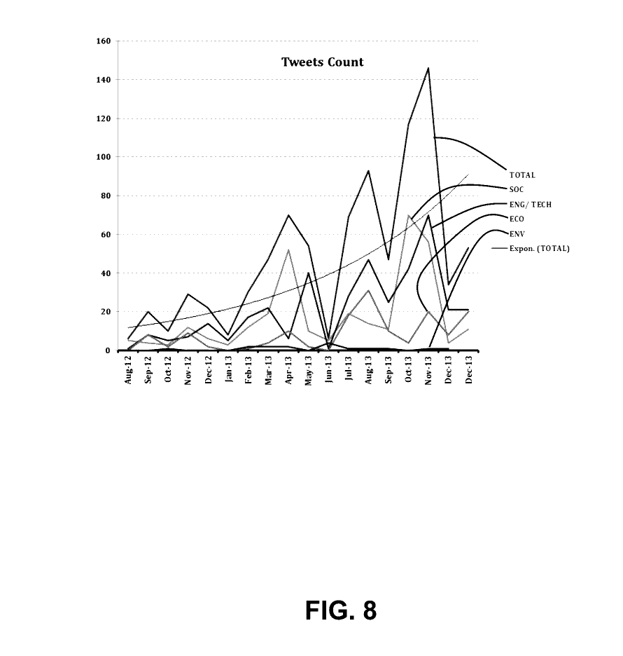

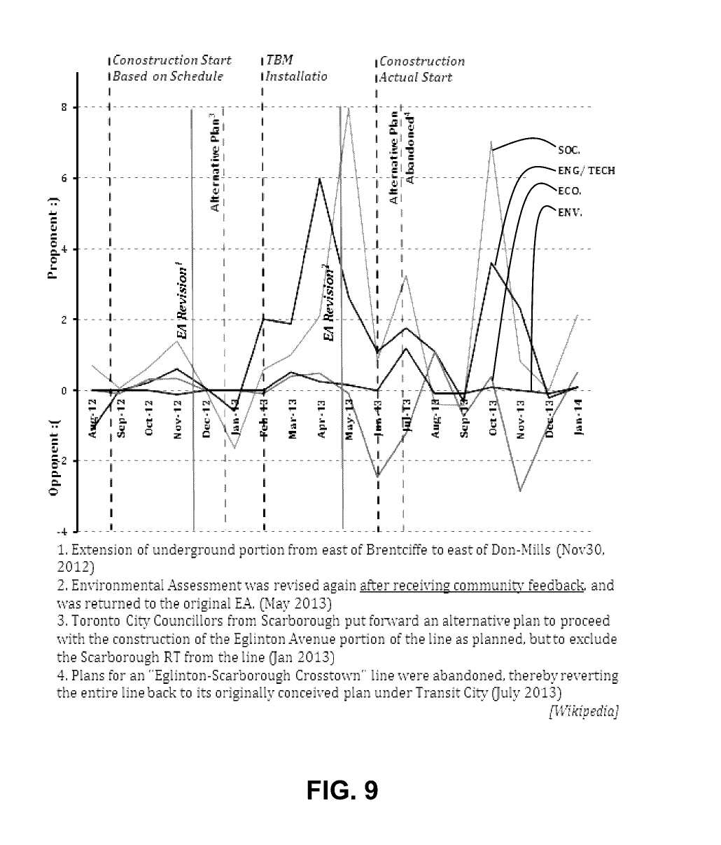

Referring now to FIGS. 8 to 9, analysis by the analysis engine 105 of a particular IDN relating to the Eglinton Crosstown project in Toronto, on Twitter will be described. Referring now to FIG. 8, shown therein is a graph showing possible stakeholder analysis data over time for a particular IDN, specifically relating to the Eglinton Crosstown project in Toronto. By selecting ‘sustainability’ as the context of analysis, collected tweets could be modeled and processed in the form of weighted vectors and aggregated in a monthly timeframe to generate the graph. The illustrated semantic space has components of sustainability as its dimensions (Social, Economic, and Environmental); as well as Engineering/Technical. The state of the IDN at the end of each time interval may be provided as the summation of all vectors collected within that interval. In the following, possible resulting PDPs will be discussed for Light Rail Transit (“LRT”) project case studies. Selecting sustainability as the context of the analysis, and taking four components of Economy, Environment, Social aspect, and Engineering/Technical aspect, together with the ‘None’ class as dimensions of the semantic space, tweets related to the Eglinton Crosstown project can be analyzed by components of the bottom-up module. Tweets could be collected over a timespan, such as from August 2012 to December 2013 for modeling, as illustrated. FIG. 8 depicts the distribution of tweets and the breakdown based on their main topics. The results of Sustweetability can be used for classifying tweets in both semantic and sentiment classes; however, with more annotated data-points, training classifiers could be used with the analysis.

The results may be provided as a PDP over time, as illustrated in FIG. 9. Some major milestones of the project, are shown on the PDP in this figure. Values shown on the vertical axis, the opinion state, are summations of normalized PageRank. Therefore, the vertical axis does not have a specific unit and the values are for comparison only. Values depicted in this figure are algebraic summations of vectors within each month. Therefore, the positive half (above the horizontal axis) represents a proponent attitude for the collective social opinion, and the negative half shoes an opponent attitude with respect to the project from different aspects. The Economic aspect (“ECO.”) is shown to be a main concern of the project followers. This PDP thus sends a clear message to decision makers that public interaction programs should emphasize the economic aspects of the project and target stakeholders' and followers' feedback in this regard.

The illustrative values shown in the PDP are algebraic summations; i.e. it is assumed that proponents and opponents in one class can cancel out each other's effects. Although this complies with the literature of stakeholder analysis and the result can provide a good overview on the collective opinions, such a cancellation may not necessarily be always holding true. Hence, parallel to an algebraic summation of the opinion, summation of positive and summation of negative ideas in each month can be considered by decision makers. These summations give a range for opinions discussed and also can help to detect cases of dialogues and disputes about the project in online social media.

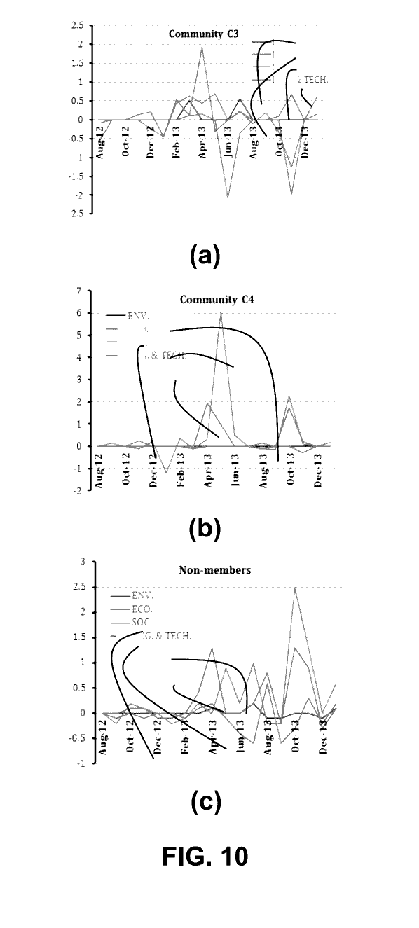

Referring now to FIG. 10, shown therein is a possible PDP of the Eglinton Crosstown LRT project on Twitter, according to communities of the IDN. An aspect of the analysis engine 105 thus connects discussed opinions to the people supporting them. This connection, at an individual level, evaluates network value of discussions based on the influence level of the person discussing them. At a higher level, groups of followers can be linked to opinions discussed to provide different insights for decision making. In some embodiments, the PDP can be presented for communities of the IDN as illustrated in FIG. 10. FIG. 10A shows a possible PDP for a community of city policy makers. FIG. 10B shows a possible PDP for a community of the public. FIG. 100 shows a possible PDP for stakeholders who are not followers of the project ID on Twitter.

PDP can thus be used as a decision support tool; decision makers can consult with such a support tool to evaluate the social opinion, concerns, reactions to decisions they made, etc. They can show which decisions influence the followers' opinions the most, and what aspects of such decisions are discussed more frequently. Aggregating such information over time can result in useful knowledge with respect to the interaction of project followers—decision makers. PDP can also provide a layout of discussions based on different communities. Community-based PDPs may be a better profiling and labeling of communities of followers, such PDPs go beyond the term-level and uncover the semantic classes discussed over time. However, performing such a profiling may be more burdensome. It may require classification of subject and sentiment for every tweet collected. Also, labeling communities based on their user-profile descriptions provides a collective picture over all (or more influential) nodes of communities. Patterns detected in the PDP may correlate with actual events in the project and some major events can be detected and tracked from monitoring PDP. Also it provides information regarding correlations between project phase and social discussions.

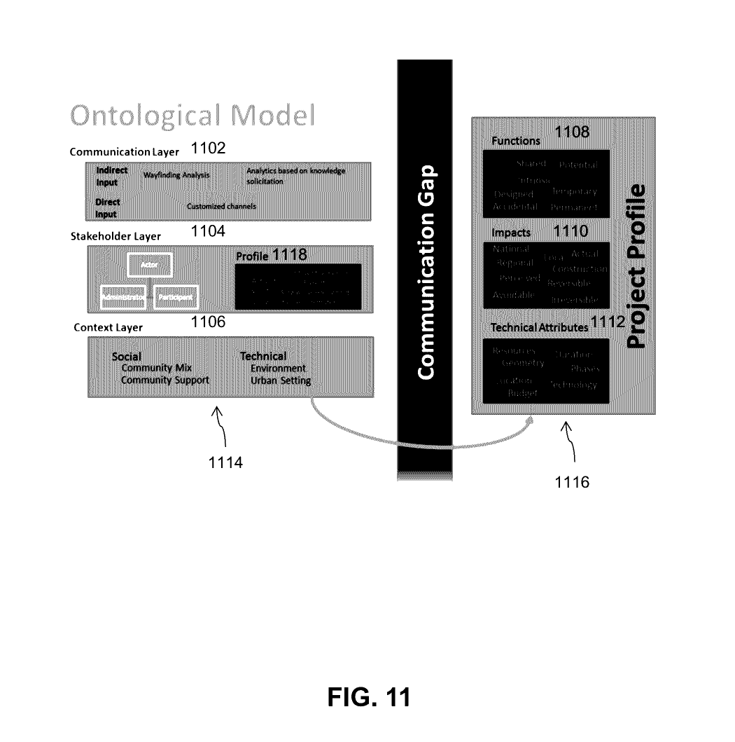

The knowledge engine module 106 of the back-end module 104 will now be described in additional detail with regards to FIGS. 11 to 23.

As discussed above, the knowledge engine 106 supports a user interface and comprises an ontology 128, a wayfinding module 130 and a recommender module 132 to extract meaningful and directed feedback from stakeholders. This engine acts as a platform for the integration of the semantic features supported by the ontology with other features that include social web mechanisms and wayfinding techniques among other techniques. The recommender and wayfinding modules depend on the ontology to add context based on the location of a project (city, neighborhood, etc.) and the type of infrastructure project (transit vs. water treatment plans). The wayfinding and recommender modules direct users to infrastructure projects that they may be interested in, in order to direct feedback. This allows the framework to create meaningful conversations about impacts, functions, and perceptions, as opposed to technical project aspects. The system propagates patterns generated by user activity and preferences (participant-based patterns) rather than mandating specific project elements. To establish this flow, users are provided with explicit functionalities to update their interests to complement default profile setups and automatic wayfinding analysis.

Referring now to FIGS. 11 to 15, the ontology 128, referred to as “eSocOnto” will now be described. The ontology 128 defines knowledge entities in the planning, design and construction process as well as the knowledge possessed by the community. The ontology focuses on representing infrastructure products through their functions and impacts; more importantly, emphasizing the order of suitable communication channels. In order to represent the formal knowledge that constitutes the community engagement process, the ontology encodes a classification of entities, and the relationships and axioms that govern them. The use of a customized knowledge base enables the development of an overlying software system which can understand the content exchanged on the system.

eSocOnto is a domain ontology that represents what is communicated as part of the community engagement process in infrastructure construction projects. The ontology is extended using a built-in application-level ontology which focuses on the functions and impacts of infrastructure in urban settings. This level of ontology traditionally suits the creation of a reasoning engine to support domain-specific middleware. Parts of this ontology could be extended to create an application ontology that is more specific to specialized applications.

As illustrated in FIG. 11, the concepts in eSocOnto are divided into two main sides, project side 1116 and community side 1114, as the two main components of the ontological model. The ontological model also highlights an important gap on the process level, and supports the bridging of this gap. On one side of this gap are three layers representing stakeholder mapping 1104, communication plans 1102 and context analysis 1006. On the other side across the gap, project attributes including technical attributes 1112, functions 1108 and impacts 1110 are represented in a manner that resembles technical project documents, more common in the engineering and design realm. The model bridges this gap using a number of concepts that represent commonalities between these two sides across the gap. The figure thus represents a two-dimensional snapshot of the model in which each concept is connected to the other concepts with varying degrees of relational strengths. The Project attributes are categorized under three parent attributes: Function, Impact, and Technical Attribute. This layout embeds into the framework the requirement of linking a project's impact on a community based on the community's distinct experiences, activities, goals and interests, as represented by its various members. In this ontology, stakeholders are represented through the Actor concept which is used in software engineering to represent individual human users, groups or software agents.

In eSocOnto, the adoption of context includes external influences in the form of culture, history, and the environment, as well as user context which incorporates user experiences, culture, social role, among other user-focused contextual attributes. Users also play an important role as encoders and decoders of communicated messages that flow through the framework; hence the medium of communication is also imposed as a contextual variable among other aspects of the communication context.

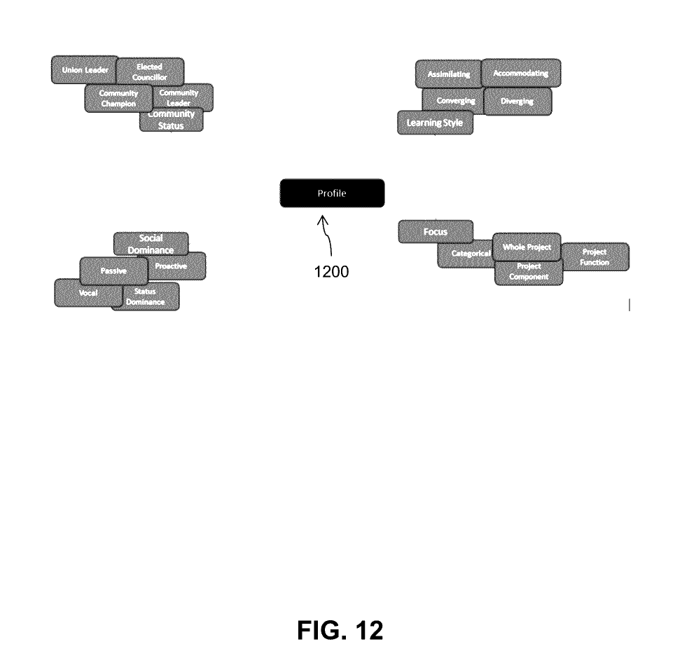

Referring to FIG. 12, shown therein is an illustrative figure showing profile modalities. Profile 1200—illustrated as element 1118 in FIG. 11—will contain information about an actor's level of education, interests, political affiliation and general attitudes such as whether a user adheres to a not-in-my-backyard mentality (“NIMBY”). While some of the profile parameters will be set by the user, other parameters will be set by other users on the system through a process of ranking and tagging. The profiles provide important information for the wayfinding and predictive functionalities of the framework.

A project can be modelled in this representation as a process that can be composed of one or more sub-processes representing subprojects, phases and stages. Typically, each process will have an outcome (e.g. a physical product: bicycle lane, bridge, or highway section) in addition to possible scenarios, mechanisms and constraints. The project as a whole has an outcome as well which may be a final deliverable. The various components of the project are modelled as attributes or, in the case of more complex components, a collection of outcome scenarios which can take the form of physical products, services or concepts (such as knowledge items, ideas or “consent”).

In the context of this ontology, functions and impacts may be differentiated from regular attributes. They share a characteristic as typically non-physical attributes but are different otherwise. In a manner similar to a user's role, a product has a role within a project called a Function. Furthermore, the Impact concept is modelled as a concept similar to Function but a special type of outcome influence.

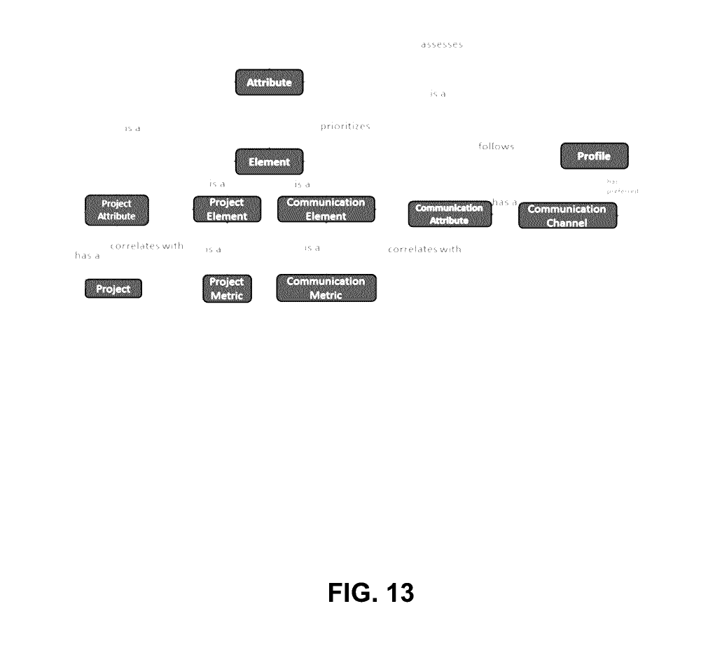

Referring now to FIG. 13, shown therein is an illustrative embodiment of a communication framework as part of the knowledge engine. In addition to the communication, profile, and role-related concepts in eSocOnto, Questions, Elements and Attributes aid in the development of application-level software systems.

Questions may be a first step in community engagement. Stakeholder surveys are a primary component of stakeholder mapping. The process relies on collecting information on stakeholder interests, preferences, and priorities, in addition to demographic information. These questions help project practitioners collect information on participants such as their address or neighbourhood, level of education, current occupation, mode of travel, frequency of mode use, organizations they represent, among other demographic, social, economic and environmental stakeholder parameters. Explicitly-defined components of user profiles can be formulated through a pool of questions presented to users on their first login and first interaction with each project. However, the set of questions that appear to the participants for each project can be defined by the project administrator through editing a selection of default questions and adding/removing questions as appropriate.

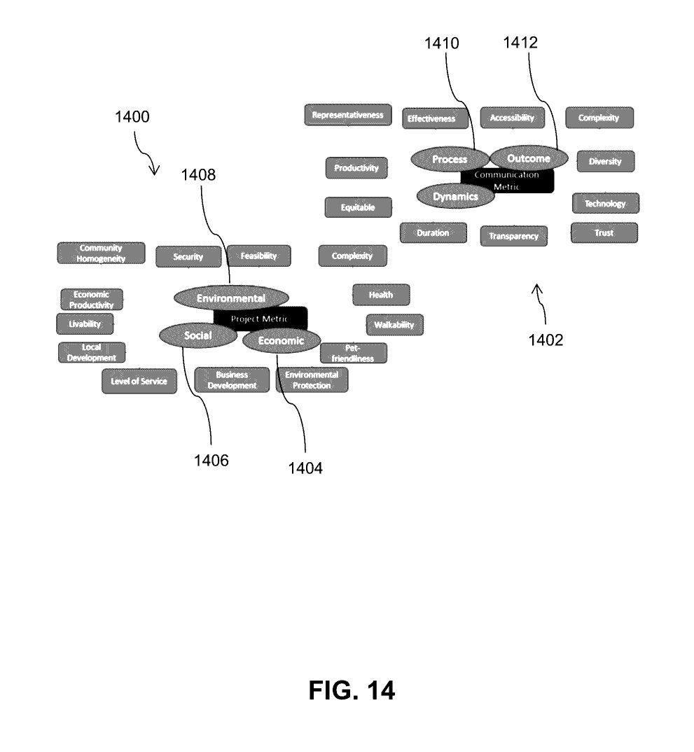

Referring now to FIG. 14, in eSocOnto, the element concept is represented as an equivalent concept to metric. This equivalence enables the categorization of metrics into two types: project metrics 1400 and communication metrics 1402. Metrics that relate to project components can be categorized along several dimensions: economic 1404, social 1406 and environmental 1408 metrics. These metrics include community homogeneity, walkability, livability, quality of service, among other project-related metrics. Communication metrics, on the other hand, evaluate the communication process 1410, its channels, tools and outcomes 1412. Such communication metrics include diversity, trust, transparency, accessibility and representativeness. As a representation of the user-centric view of infrastructure, project components are viewed through the role they play. This role is, in turn, evaluated through a metric, referred to here as an element concept. These elements represent walkability, livability, appeal, safety, quality of service among other metrics used to evaluate cities, neighbourhoods, infrastructure and communities. Elements can be quantitative or qualitative depending on the nature of what is being measured. For example, some may have defined and standardized indices while others such as appeal are not and may use a more fuzzy scale.

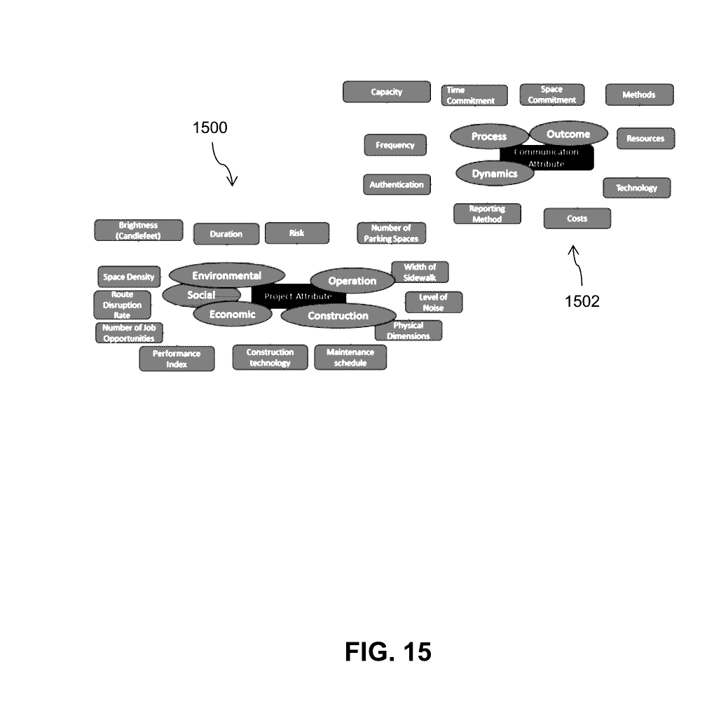

Referring now to FIG. 15, the attribute component is a representation of all the physical and non-physical parameters of projects, users, and products. For example, a sidewalk can have attributes such as average width, pavement material, zoning structure, landscaping layout. Attributes follow a classification, similar to metrics, of project 1500 and communication 1502 attributes as the two main categories as shown in FIG. 15.

The eSocOnto ontology described above formalizes the knowledge encapsulated within the eSoc framework. This eSocOnto framework acts as a platform for the integration of the semantic features supported by the ontology with other features that include social web mechanisms and wayfinding techniques among other techniques. The eSoc framework is more than a communication framework; its functions extend to facilitating meaningful dialogue, and enables bottom-up knowledge flow via a top-down framework. The eSoc framework propagates patterns generated by user activity, learning styles and preferences (participant-based patterns) rather than mandating specific, predefined project elements as practiced in traditional project consultations. To establish this flow, users are provided with explicit functionalities to update their interests to complement default profile setups and automatic wayfinding analysis. The knowledge engine is designed as an automated framework that utilizes a social, web-based, semantic environment in which community members and project administrators can access interoperable, ready-made, analysis modules.

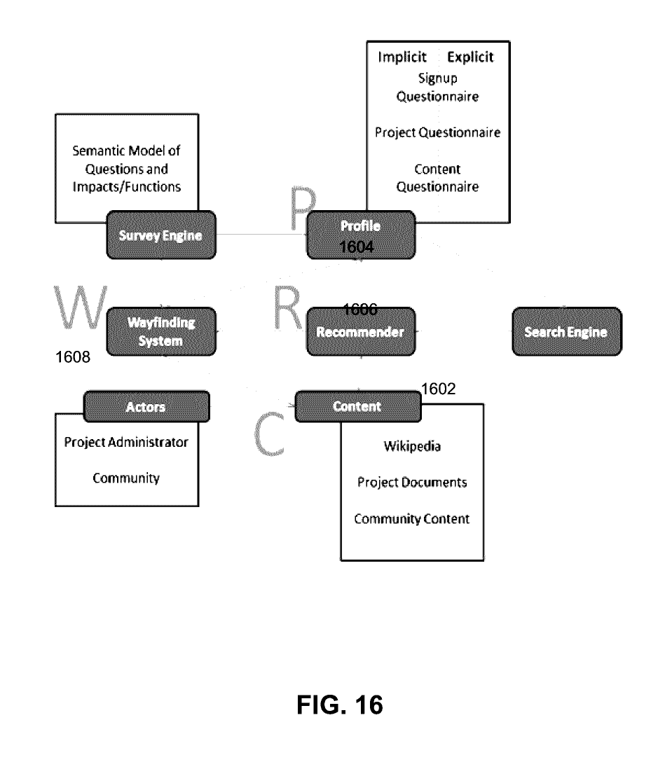

Referring now to FIG. 16, the framework's architecture may comprise four main modules: content 1602, profile 1604, recommender 1606, and wayfinder 1608. These modules employ the knowledge component from the ontology, wayfinding and analytics to maintain a bottom-up flow of knowledge, enhance the user experience, and facilitate project analytics.

Referring now to content module 1602, data, information, and knowledge that flow through the framework can be generated and consumed by either project administrators or community participants. According to this classification, there are three kinds of content: project documents, user-generated content, and general content. Community-generated content can take the form of complaints, questions, assertions, or other general comments. General content (such as from Wikipedia™) is generated neither by project teams or by the community.

Referring now to profile module 1604, based on the core eSocOnto ontology, a number of preset profiles may be provided. These different types of profiles are fed into the framework which breaks down the process of creating a profile into two forms: explicit (based on questions and feedback from the user) and implicit (based on the user's activity). A profile is continually updated and enhanced as user activity and new content constantly provide additional data. An explicit profile is created based on responses by the user to preset questions at three different points. Initially, user registration on the framework involves two of these points as users provide demographic information as well as general information about their preferences, priorities and interests. The third point of explicit user profile building occurs whenever a user accesses a project. These profile attributes can vary for each project but contribute to the user's profile. In addition to these three ways of explicitly defining a profile, users can also actively update their profile at any point. An implicit profile is created through the continuous process of activity tracking and explicit profile updating. This process relies heavily on the wayfinding module. It also relies on the premise that users may act contrary to their initial responses or their interests and preferences may change over time, or from project to project. For example, a user who expresses initial interest in economic issues over environmental issues through explicit responses will initiate the creation of an economy-heavy profile. This user may in reality visit more environmental content than content labelled as economic, resulting in an implicit profile update to indicate this trend.

Referring now to recommender module 1606, the role of enhanced profiles is essential for achieving higher accuracy in customizing content for users by the recommender module. This customization process also depends on the content previously viewed and users they follow, and projects they follow.

Referring now to wayfinding module 1608, as users gain access to relevant information through the recommender module, the analysis and enhancement of their profile is fed through a variety of wayfinding and recommender techniques to update these profiles.

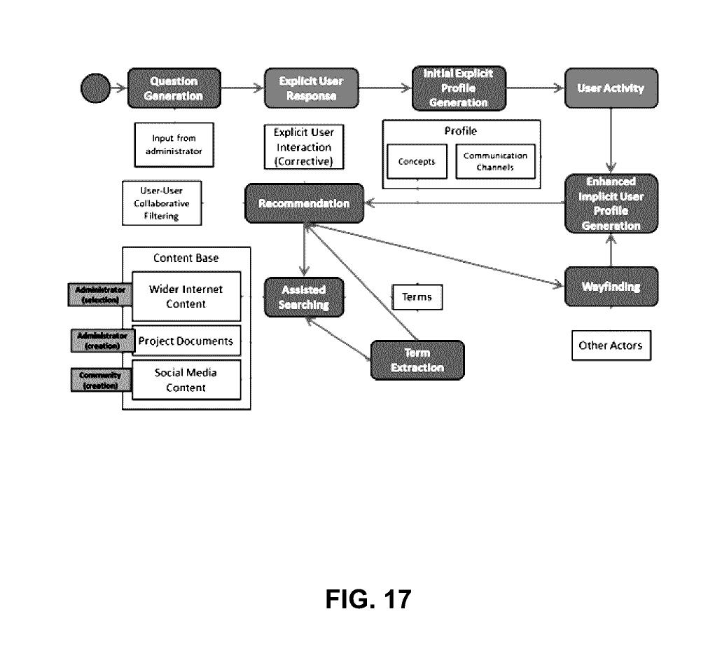

Referring to FIG. 17, shown therein are process flows for the eSoc framework. This form of implementation for the eSoc framework requires two process flows to be linked. The main process realms for the eSoc framework are the participant process and the project administrator process, in addition to system processes. While the administrator and participant process lines intersect at certain points, they contain different functions otherwise.

In order to facilitate analysis, implement the wayfinder and recommender modules and the various functions for participants and administrators described above, a number of techniques may be incorporated into the eSoc framework.

Techniques will now be described that can be implemented by the recommender module to provide the functionality described above. While users can follow documents and projects, they do not provide specific ratings like other recommender systems for movies or online retail. Instead, a rating vector may be implicitly generated. This vector is used to indicate similarity and generate recommendations for documents and projects for which the user has no rating. Collaborative filtering uses the preferences and interests of existing users to predict the preferences of other users on a system. Typical collaborative filtering techniques such as the Slope One family of techniques depend on ratings of items by users as an item-based form of recommendation, although in this case using a simple predictor instead of linear regression. Hybrid techniques are common and can provide comparable performance to other basic forms of techniques through added features. In the case of the knowledge engine, three types of technique needs have been identified for different contexts: system startup, new user, default recommender.

Techniques can be automatically selected from a set of techniques. Different techniques are contemplated depending on the case. The engine may allow project teams to specify recommender algorithms for each project to override automated algorithm selection. The basic form of the techniques includes basic user and item vectors and a rating matrix.

User iε{1,2, . . . ,m}

Item jε{1,2, . . . ,n}

The recommender module can use techniques to generate ratings in matrix cells where no rating was provided by the user for a specific item. Three illustrative techniques are shown in Tables 1, 2 and 3 below:

TABLE 1
Project Recommendation

```
    Case 1: Cold start with some users and some projects but
    empty matrix and no followed projects
Trigger 1
New project created
Trigger 2 (or)
Current project tags edited
Algorithm
    Retrieve initial rating matrix
For each user in all users list
For each project in all projects list
        // Calculate similarity to user
// Calculate Manhattan distance (map) between location of project and
home location of user
If distance < 1km loc_score = 5
Else If distance < 5km loc_score = 4
Else If distance < 10km loc_score = 3
Else If distance < 20km loc_score = 2
Else If distance < 50km loc_score = 1
Else If distance >= 50km loc_score = 0
      // Calculate tag similarity with interests
match_score = number of matched tags/total number of tags * 10
Score = (loc_score *2 + match_score) / 2
Store Score in database
Note:
Lines marked with two slashes “//” are explanatory notes within the algorithm pseudocode.
```

TABLE 2
Project Recommendation

```
Case 2: New project created
Condition: some projects are followed by some users
Trigger 1
New project created
Trigger 2 (or)
    Algorithm
    Retrieve current rating matrix
For each user in all users list
For each project in all projects list (except new project)
// Calculate Manhattan distance (map) between location of project and
home location of user
If distance < 1km loc_score = 5
Else If distance < 5km loc_score = 4
Else If distance < 10km loc_score = 3
Else If distance < 20km loc_score = 2
Else If distance < 50km loc_score = 1
Else If distance >= 50km loc_score = 0
      // Calculate tag similarity with interests
match_score = number of matched tags/total number of tags * 10
Score = (loc_score *2 + match_score)/2
// Find similar projects in row
Calculate similarity based on tags (if a project is followed by this user,
    multiply score by 1.5, score cannot exceed 10)
Score = average of top 5 similar projects and Score for this new project
Store Score in database
Note:
Lines marked with two slashes “//” are explanatory notes within the algorithm pseudocode.
```

TABLE 3
Project Recommendation

```
Case 3:
Trigger 1
New User completes questionnaire
Trigger 2 (or)
User edits interests
Algorithm
    For all projects for this user
        // Calculate similarity to user
// Calculate Manhattan distance (map) between location of project and
home location of user
If distance < 1km loc_score = 5
Else If distance < 5km loc_score = 4
Else If distance < 10km loc_score = 3
Else If distance < 20km loc_score = 2
Else If distance < 50km loc_score = 1
Else If distance >= 50km loc_score = 0
    // Calculate tag similarity with interests
match_score = number of matched tags/total number of tags * 10
Score = (loc_score *2 + match_score) / 2
Store Score in database
Note:
Lines marked with two slashes “//” are explanatory notes within the algorithm pseudocode.
```

In cases when users do not explicitly rate content, a rating matrix can be generated using a similarity rating. In the case of text-based content such as project documents in the knowledge engine, similarity may depend on Term Frequency (“TF”). TF scores take into account the length of the document to remove inconsistencies caused by documents of different lengths being compared. Furthermore, other measures such as Term Frequency Inverse Document Frequency (TF-IDF) may be used. The advantage of using TF-IDF is that it helps focus on concepts unique to each content item. However, if core concepts only appear once or twice in a document, they may not be captured despite their importance. Recommenders that depend on this method can also fail if combined with search engines where users engage in “poor searching,” an issue related to the choice of search words and extracted concepts. The knowledge engine selects specific algorithms, user-item and user-user matching for recommending projects which have a unique project vector containing properties such as location and impacts. In the case of articles within projects, the knowledge engine uses a different set of algorithms under the knowledge-based and constraint-based family of recommenders, as shown in Table 4 below. Article vectors primarily include type of media, purpose of article, and content type.

TABLE 4
Article Recommendation

```
Algorithm:
    Article a has properties p₁,p₂,....pₙ
From user requirements,
    Requirement r which belongs to R, e.g. Article content = 70%
    video
    wᵣ = importance weight of requirement r (retrieved from eSocOnto)
Calculating similarity:
    For all requirements r in R, similarity(a,R) = Sum (wᵣ * sim(a,r) /
    sum(wᵣ)
    sim(a,r) = 1 − |pᵣ(a)−r| / max(r) − min(r)
Article property value depend on dominant value:
Content_type_social = 0...100
Content_type_economic = 0...100
Content_type_environmental = 0...100
Article_purpose = Construction Notice, Design Review, Meeting
Notice, Policy Change
Media type_av_media = 0...100
Media_type_text = 0...100
Reading time = Less than 1, 1-2, 2-5, 5-10, 10-15, 15-20,
longer than 20
```

Wayfinding may contribute to completing profiles. Berrypicking may be used by the wayfinding module for basic profiles while active profiles with above average transactions may follow a TF-IDF wayfinding algorithm as presented in Wikispeedia by West and Leskovic (2012). The choice of technique may be dependent on the context and profile activity. The technique provided may depend on defining hubs and constantly assessing the similarity of routes to user profiles.

Referring now to Tables 5 to 10, the knowledge engine may comprise four modules for content enhancement: project, communication, semantic, and wayfinding modules. The knowledge engine may also comprise Social and Reporting Modules. Together, these six modules analyze information within the framework and customize the user experience.

Referring now to Table 5, shown therein is an illustration of the inputs, outputs and features of the project module. The project module maintains the integrity of projects controlled through this module. It also hosts the project's attributes, functions and impacts.

TABLE 5

| Inputs | Features | Outputs |
|---|---|---|
| Project Profile | The administrator can input project | Enhanced |
| Components, | information into the project module | Project |
| Technical | which, in turn, enhances the project | Profile |
| Attributes, Schedules | profile with additional knowledge | Annotated |
| and Budgets, | from participants and other sources | Functions, |
| Functions, Impacts | external to project documents | Impacts |
| and | | and |
| Communication Plan | | Attributes |

Referring now to Table 6, shown therein is an illustration of the inputs, outputs and features of the semantic module. The semantic module may maintain content for the framework. This module represents context through a number of profiles including contextualized project and stakeholder profiles represented in this table.

TABLE 6

| Inputs | Features | Outputs |
|---|---|---|
| Project Profile | The module maintains the integrity | Contex- |
| Components, | of the knowledge framework | tualized |
| Technical | through the existing knowledge | Profiles |
| Attributes, Schedules | base. It also encapsulates | and |
| and Budgets, | additional knowledge | Attributes |
| Functions, Impacts and | acquired from the users | |
| Communication Plan | to produce contextualized | |
| Stakeholder Profiles | knowledge which can be matched | |
| Personal and | across projects. | |
| Professional Attributes, | | |
| Communication Style, | | |
| Related Impacts | | |

Referring now to Table 7, shown therein is an illustration of the inputs, outputs and features of the wayfinding module. The wayfinding module has the aim of customizing information. This module customizes information paths to improve the user experience through profile enhancement and customizing content.

TABLE 7

| Inputs | Features | Outputs |
|---|---|---|
| Project Profile | Established wayfinding | Customized |
| Components, | algorithms support this module | Information, |
| Technical | in using project and | Customized |
| Attributes, Schedules | stakeholder profiles to map | Information |
| and Budgets, | information paths and, whenever | Path, Gaps |
| Functions, Impacts and | missing, complementing existing | in |
| Communication Plan | information with external | Knowledge |
| Stakeholder Profiles | sources through information | |
| Personal and | retrieval. | |
| Professional Attributes, | | |
| Communication Style, | | |
| Related Impacts | | |

Referring now to Table 8, shown therein is an illustration of the inputs, outputs and features of the communication module. In addition to customizing content, the customization of communication channels is invaluable to the communication process. This module uses projects and user profiles to support the communication process.

TABLE 8

| Inputs | Features | Outputs |
|---|---|---|
| Project Profile | Stakeholder profiles are matched | Customized |
| Components, | with different communication | Communica- |
| Technical | channels that are suitable for | tion |
| Attributes, Schedules | their learning needs and | Channels |
| and Budgets, | preferences. | |
| Functions, Impacts and | Each stakeholder profile may be | |
| Communication Plan | assigned more than one | |
| Stakeholder Profiles | communication channel | |
| Personal and | depending on the project's | |
| Professional Attributes, | profile, and the variety of | |
| Communication Style, | impacts and functions | |
| Related Impacts | the user is interested in | |

Referring now to Table 9, shown therein is an illustration of the inputs, outputs and features of the social module. User-generated content is enhanced through a number of social mechanisms managed by the social module. This component also uses profiles and context to produce ranked feedback and aggregated alternatives.

TABLE 9

| Inputs | Features | Output |
|---|---|---|
| Enhanced Project Profile, | Comments, tags, ranking and other | Ranked |
| Enhanced Stakeholder | social web features are used as a | and |
| Profile, Contextualized | feedback mechanisms that adjusts | Enhanced |
| Profiles and Attributes, | priorities and enhances predictions | Output |
| Knowledge Gaps | made by other modules. The | |
| | continuous feedback generated by | |
| | this module also ensures that the | |
| | framework's primary mode of | |
| | operation, beyond the initial setup, | |
| | is bottom-up. | |

Referring now to Table 10, shown therein is an illustration of the inputs, outputs and features of a reporting and aggregation module. The various modules may produce conflicting output that needs to be resolved before information is displayed to project administrators and practitioners. The Reporting and Aggregation Module completes this task through creating lists that integrate output from the Social Module to qualify this information. It also links the various impacts, functions and risks to their respective technical attributes for easier cross-referencing during later stages of the project such as construction and operation.

TABLE 10

| Inputs | Features | Outputs |
|---|---|---|
| Enhanced Project Profile, | Content alignment | Crowdsourced, |
| Enhanced Stakeholder | Analytics by | Peer-Ranked |
| Profile, Contextualized | content groups | Alternatives, |
| Profiles and Attributes, | | Project Value, |
| Knowledge Gaps | | Concerns, Impacts |
| | | and functions as |
| | | Percieved |

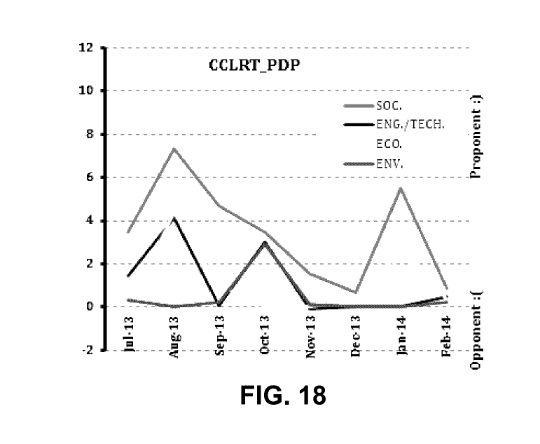

PDP of three other LRT projects (Central Corridor, Atlanta Streetcar, and M1-Rail) are shown in FIGS. 18 through 20, in monthly timeframes. Similar to the previous case, these profiles are formed based on the monthly activity of Twitter followers of these projects. Sustainability is selected again as the analysis context, bringing the PDP of these projects into the same semantic space as that of Crosstown project. While both Atlanta streetcar and Central Corridor were in final stages of construction, during data collection, the PDP of M1-Rail reflects the pre-construction phase of the project.

Central Corridor (Metro Green Line) LRT—is built on over 18 Km of exclusive right of way between downtown St. Paul and downtown Minneapolis, Minn., and links five major centers of activity in the Twin Cities region. Construction began in late 2009 and the operation started in June 2014. Construction was funded by federal (50%), state (around 10%), and local (around 40%) governments. As the project was believed to improve the adjacent neighbourhoods and strengthen the regional economy, a group of local and national funders formed a coalition called Central Corridor Funders Collaborative (CCFC) to support the project.

Official and technical decision makers of the project engaged the public community in the process at different stages and from different aspects. One full entire section of the construction contract was solely devoted to public involvement, which required the contactor to submit a public involvement plan and a monthly community involvement report. The project's environmental impact statement report published in June 2013 presented a comprehensive list of public outreach efforts and their outcomes. Based on that report, more than 25,000 participants had presented ideas at 1,150 public meetings. Open forums and open houses, community meetings and one-on-one meetings, visioning sessions with artists who design station art (for public input about the history and culture of the station areas), booths staffed by the project at different community events, and individuals' and organizations' outreach staff were among other tools and techniques used in this project to assure close participation of the public community.

The project also had a Twitter account since April 2010. A total of 331 tweets were collected for this project in a period of eight months between July 2013 and February 2014. In the PDP of the Central Corridor project (FIG. 18), the Engineering/Technical issues in most of the months have the highest number of tweets. The higher level for the Social category (compared to the Engineering) in the PDP in spite of its lower number of tweets may either indicate that people discussing the Social category have had a higher level of influence, or the Engineering category has had a balance of positive and negative comments. Skimming data-points shows that the former is the case; tweets with higher network values have been discussing Social sustainability aspect of the project with a positive sentiment.

The city of Atlanta, Ga., recently, decided to add a modern streetcar system in an East-West light rail route, shared with other traffic on-street lanes in a total length of 4.3 Km and having 12 stops. The project is the result of a public-private partnership between the City of Atlanta, the business community organization ADID (Atlanta Downtown Improvement District), MARTA (Metropolitan Atlanta Rapid Transit Authority), and the Federal government (FTA-Federal Transit Administration and US Department of Transportation). The city of Atlanta (MARTA) is the owner and the FTA grant recipient. a non-profit organization called Atlanta Streetcar Inc. (ASC), comprised of the city's top businesses, government, and community leaders, was founded in 2003 to support and lobby for the return of the streetcar to Atlanta. Construction started in early 2012 and was performed in three major phases. Operation began in December 2014.

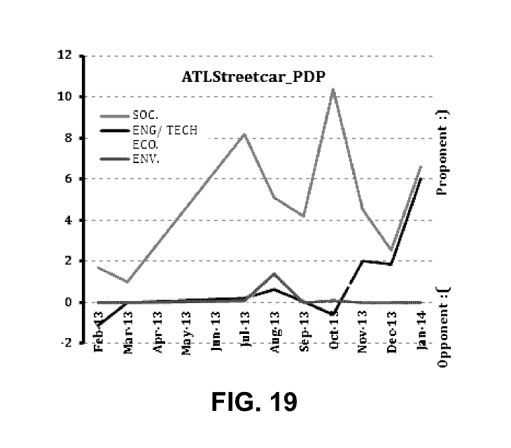

Since February 2011, the project has had an active Twitter account. Data collection over a period of one year (from February 2013 to end of January 2014) resulted in a total of 410 tweets. PDP of Atlanta streetcar project, formed from analysis of these tweets is shown in FIG. 19. As seen in this figure, Social sustainability receives the highest number of tweets, and also has the highest level of proponent opinions. Here again, the Environmental sustainability is the least discussed category. Economic sustainability started receiving attention after July 2013, when it was announced that the project is $2 million under budget. Later in December 2013, when it was announced that the soon-to-be-completed LRT line would not be operated by MARTA-Metropolitan Atlanta Rapid Transit Authority (due to cost structures, unattractiveness of their proposal, and the insurance that they could not accommodate), the Economic branch of the PDP has gone to the negative zone. But in January of 2014, the branch has shifted back to the positive half with tweets and news related to new investments in and along the LRT line.

A 5.3 Km long light rail in the public right-of-way within the city of Detroit, Mich. is planned to connect the downtown and the new center of the city. The project is composed of 5.3 Km long railway and is estimated to cost $140 million which will be granted through a public-private partnership between the Detroit Department of Transportation (DDOT) and a Michigan non-profit corporation called M-1 Rail, formed mainly by local business leaders in 2007 to develop and potentially operate the system over a term of 10 years. As it is mentioned in the M1-Rail business plan (April 2012), the project does not require any business or residential dislocations, and the streetcar service will be co-mingled with vehicular traffic. Construction of the project was bid in the form of a design build contract in May 2013, and two more contracts will be awarded for construction of a vehicle storage and maintenance facility, and for the streetcar vehicles themselves.

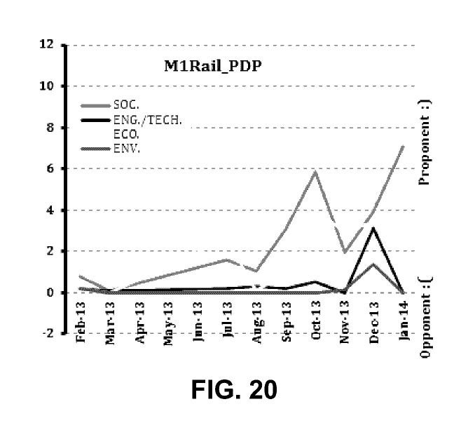

M1-Rail created its Twitter account in January 2013, and the data collected over a period of one year (from February 2013 to end of January 2014) resulted in a total of 291 relevant tweets, used to generate the project PDP. The PDP of M1-Rail project covers the full year between announcement of allocating federal grant supports (in January 2013) and the beginning of construction (in December 2013). The final approval of the project in April and awarding the first construction contract in July are among important milestones of the project in this period. As it is shown in FIG. 20, during this period the Economic aspect is at the centre of attention in terms of both number and sentiment of tweets; in all 12 months it lies above the Engineering/Technical category. This is a unique observation (in a project studied over its pre-construction phase). The Environmental, similar to the case of Eglinton Crosstown, has the lowest share in the discussion profile, and the PDP never visits the negative zone in any of the four categories.

Various embodiments are described above relating to the analysis of public sentiment for infrastructure projects, but the embodiments are not so limited. The embodiments described herein may apply to other contexts with necessary modifications.

Although the foregoing has been described with reference to certain specific embodiments, various modifications thereto will be apparent to those skilled in the art without departing from the spirit and scope of the invention as outlined in the appended claims. Particularly, although the foregoing has been described with reference to infrastructure project stakeholder analysis, the systems and methods described herein may be applied in other contexts where stakeholder analysis is required. The entire disclosures of all references recited above are incorporated herein by reference.

1. A system for utilizing one or more internet-based sources including internet social networks to perform automated stakeholder sentiment analysis relating to infrastructure projects, the system comprising:
a user interface module configured to permit a user to obtain the stakeholder sentiment analysis;
a knowledge engine comprising a recommender module and a wayfinder module for receiving structured and contextualized stakeholder analysis data through the user interface;
an analysis engine comprising a subject classifier, a sentiment classifier, and a processing module, configured to:
train the subject classifier and the sentiment classifier using the structured and contextualized stakeholder analysis data;
retrieve a plurality of units of unstructured stakeholder analysis data from the one or more social networks;
generate a subject-sentiment dyad for each unit by applying the trained classifiers to the unstructured stakeholder data;
generate importance data by evaluating the importance of stakeholders associated with the unstructured stakeholder data, the evaluating comprising determining a social influence of the stakeholder utilizing a social graph of nodes and edges for the stakeholder from the one or more social networks;
transforming the importance data to a set of directed vectors having magnitudes and directions corresponding to the dyads and importance data;
generate a project profile from the directed vectors; and
providing the project profile to the user via the user interface.

2. The system of claim 1, wherein the knowledge engine comprises an ontology for formalizing and automating understanding of content by propagating patterns generated by user activity, learning styles and preferences.

3. The system of claim 2, wherein the ontology comprises infrastructure concepts including the location of a project and the type of infrastructure project.

4. The system of claim 2, wherein the ontology utilizes domain documents comprising public meeting records, project documents, and regulatory guidebooks for modelling or building context of topics and subjects.

5. The system of claim 1, wherein the recommender module and the wayfinder module direct users to infrastructure projects of potential interest.

6. The system of claim 5, wherein the recommender module and the wayfinder module further provide the user with direct feedback including impacts, functions, and perceptions.

7. The system of claim 1, wherein the recommender module generates a rating vector used to indicate similarity and generate recommendations for documents and projects for which the user has no rating.

8. The system of claim 1, wherein the recommender module applies collaborative filtering to utilize the preferences and interests of other users to predict the preferences for the user.

9. The system of claim 1, wherein the direction of the vector is a first direction for a positive sentiment of the dyad and a second direction opposing the first direction for a negative sentiment.

10. A method for automated stakeholder sentiment analysis relating to infrastructure projects utilizing one or more internet-based sources including internet social networks, the method comprising:
receiving structured and contextualized stakeholder analysis data through a user interface;
training, by a machine learning approach, a subject classifier and a sentiment classifier using the structured and contextualized stakeholder analysis data;
retrieving a plurality of units of unstructured stakeholder analysis data from the one or more social networks;
generating, by an analysis engine comprising one or more processor, a subject-sentiment dyad for each unit by applying the trained classifiers to the unstructured stakeholder data;
generating importance data by evaluating the importance of stakeholders associated with the unstructured stakeholder data, the evaluating comprising determining a social influence of the stakeholder utilizing a social graph of nodes and edges for the stakeholder from the one or more social networks;
transforming the importance data to a set of directed vectors having magnitudes and directions corresponding to the dyads and importance data;
generating a project profile from the directed vectors; and
providing the project profile to a user via the user interface.

11. The method of claim 10, further comprising evaluated the received structured and contextualized stakeholder analysis data against an ontology for formalizing and automating understanding of content by propagating patterns generated by user activity, learning styles and preferences.

12. The method of claim 11, wherein the ontology comprises infrastructure concepts including the location of a project and the type of infrastructure project.

13. The method of claim 11, wherein the ontology utilizes domain documents comprising public meeting records, project documents, and regulatory guidebooks for modelling or building context of topics and subjects.

14. The method of claim 10, further comprising directing the user to infrastructure projects of potential interest based upon the analysis.

15. The method of claim 14, further comprising providing the user with direct feedback including impacts, functions, and perceptions.

16. The method of claim 10, further comprising generating a rating vector used to indicate similarity and generate recommendations for documents and projects for which the user has no rating.

17. The method of claim 10, further comprising applying collaborative filtering to utilize the preferences and interests of other users to predict the preferences for the user.

18. The method of claim 10, wherein the direction of the vector is a first direction for a positive sentiment of the dyad and a second direction opposing the first direction for a negative sentiment.
